(19) United States
(12) Patent Application Publication
(10) Pub. No.: US 2008/0193710 A1
(43) Pub. Date: Aug. 14, 2008

(54) Process and a Plant for Making a Multi-Layer Panel and Multi-Layer Panel Thus Made

(76) Inventor: Alfonso Branca, Milano (IT)

Correspondence Address: GOTTLIEB RACKMAN & REISMAN PC, 270 MADISON AVENUE, 8TH FLOOR, NEW YORK, NY, 10016-0601, US

(21) Appl. No.: 11/572,290

(22) PCT Filed: Jul. 21, 2005
(86) PCT No.: PCT/EP2005/007979

§ 371 Date: Jan. 18, 2007

(30) Foreign Application Priority Data
Jul. 23, 2004 (IT) MI2004A 001491

(51) Int. Cl. B32B 3/12; B29C 65/00; B32B 3/00

(52) U.S. Cl. 428/116; 156/148; 428/172; 156/510

(57) ABSTRACT

The process for making a multi-layer panel consists of applying a first (3) and second (4) fibre-based material on the opposite faces of a core (2) of the panel (1), joining the first and second material through a needling operation through the thickness of the core, carrying out the impregnation of the first and second fibre-based material with a resin-based material and introducing the resin-based material inside the needling holes (6) for their entire extension, and polymerising the resin-based material so that at least the polymerised resin-based material present in the needling holes defines a plurality of structural rigidifying elements (5) that connect the first and second fibre-based material.

The present invention refers to a process and a plant for making a multi-layer panel and the multi-layer panel thus made.

For some time multi-layer panels have been present on the market having a core on the opposite faces of which sheets of composite material are applied that give great strength to the overall structure.

The structure of a multi-layer panel foreseeing reinforcement sheets made from composite material, consisting of a resin-based matrix in which a fibrous phase is dispersed, is particularly advantageous due to the high ratio between mechanical strength and weight, and can thus have various applications in different technological fields, from the building trade to the transport sector, etc.

Such a panel structure can nevertheless suffer from various drawbacks due above all to not always being able to optimally resist delamination between core and outer reinforcement sheets, and to not always being able to withstand mechanical stresses above all in the direction perpendicular to the main plane on which it lies.

In order to at least partially overcome these drawbacks it has been proposed to fixedly join together the reinforcement sheets with a sewing operation carried out through the core of the structure, but such a method is extremely laborious and burdensome in terms of time and therefore is also expensive and not very productive.

The technical task proposed of the present invention is, therefore, that of making a process for making a multi-layer panel that allows the aforementioned technical drawbacks of the prior art to be eliminated.

In this technical task a purpose of the invention is that of making a process for making a multi-layer panel that allows a multi-layer panel to be obtained having an optimal capability to resist delamination and mechanical stresses in the direction perpendicular to the plane on which it lies.

Another purpose of the invention is that of making a process for making a multi-layer panel that is simple and highly productive.

The technical task, as well as these and other purposes, according to the present invention, are accomplished by making a process for making a multi-layer panel, characterised in that a first and second fibre-based material is applied on the opposite faces of a core of said panel, said first and second fibre-based material are joined through a needling operation through the thickness of said core, said first and second fibre-based material are impregnated with a resin-based material and said resin-based material is introduced inside the needling holes for their entire extension, and said resin-based material is polymerised so that at least the polymerised resin-based material present in said needling holes defines a plurality of structural rigidifying elements that connect said first and second fibre-based material.

The present invention also discloses a multi-layer panel structure, characterised in that it comprises a core arranged between a first reinforcement sheet made from composite material and a second reinforcement sheet made from composite material joined through needling through the thickness of said core, said structure also having a plurality of structural rigidifying elements that connect said first and second reinforcement sheet, said rigidifying elements comprising at least one polymerised resin-based material present inside the needling holes.

Last but not least the present invention discloses a plant for continuously making a multi-layer laminate comprising a core arranged between a first reinforcement sheet made from composite material and a second reinforcement sheet made from composite material, characterised in that it has a feed unit of a first and second fibre-based material on the opposite sides of said core, a needling unit to join fibres of said first and second fibre-based material, an impregnation unit of said fibres with a resin-based material, said impregnation unit having pressing means suitable for applying a pressure on said resin-based material so as to ensure the introduction of said resin-based material also along the entire extension of the needling holes passing through the thickness of said core, a forming unit carrying out, through suitable heat treatment, the polymerisation of said resin-based material, and a cutting unit of said laminate thus formed.

One of the salient aspects of the invention is given by the use of needling to join the fibre reinforcement materials present outside the panel.

A needling unit allows two outer fibre reinforcement materials to be joined through cores of different thickness, or through a core even having variable thickness, without substantially having to undergo structural modifications or complications and without the risk of modifying or penalising its performance.

This is particularly advantageous especially compared to a needling unit conventionally adopted for the same purpose, which is not as adaptable in such a flexible and easy way when it is made to operate on cores of different thickness or on a core with variable thickness. Indeed, in such a case, unless complex structural adaptations are carried out, defective operation of the sewing unit can occur with the production of needling points that are too loose or too tight and/or with possible breaking of the sewing thread.

Other characteristics of the present invention are defined, moreover, in the subsequent claims.

Further characteristics and advantages of the invention shall become clearer from the description of a preferred but not exclusive embodiment of the process and a plant for producing a multi-layer panel according to the finding, illustrated for indicating and not limiting purposes in the attached drawings, in which:

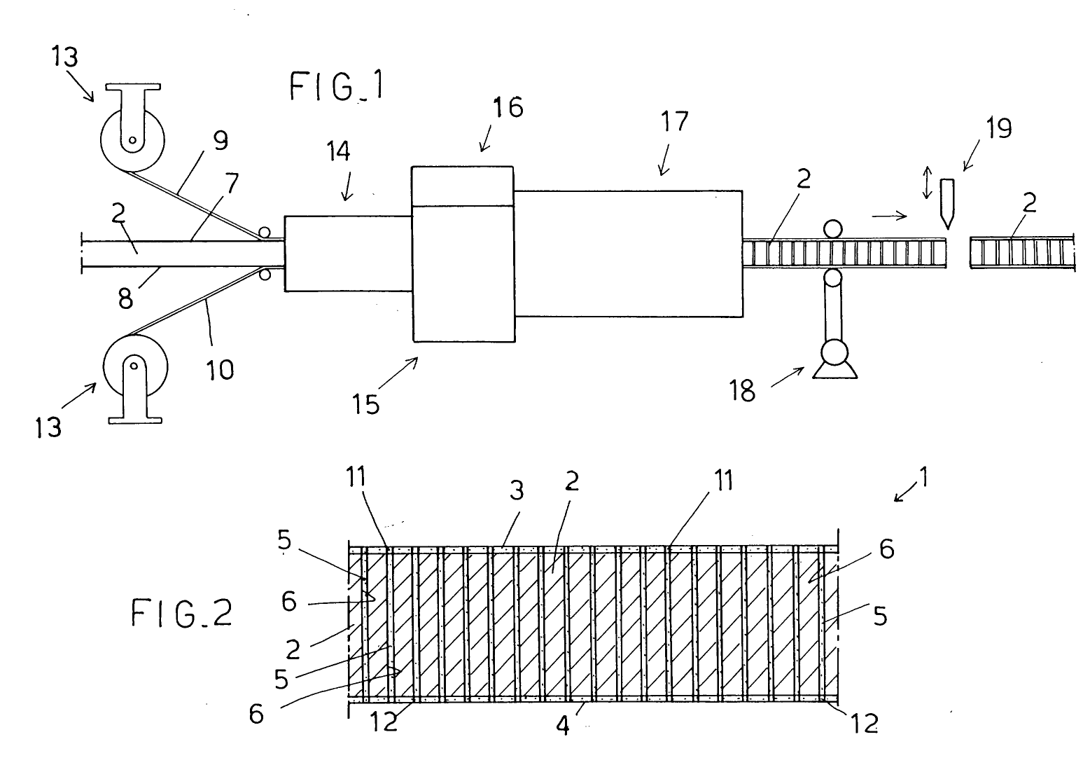

FIG. 1 shows a schematic view of a plant according to the invention; and

FIG. 2 shows a schematic view of a section of a multi-layer panel according to the invention.

With reference to the quoted figures, a multi-layer panel structure according to the invention is shown wholly indicated with reference numeral 1.

The panel 1 comprises a core 2 arranged between a first reinforcement sheet 3 made from composite material and a second reinforcement sheet 4 made from composite material.

The panel structure 1 has a plurality of structural rigidifying elements 5 that connect the first and second reinforcement sheets 3 and 4.

The rigidifying elements 5 comprise at least one polymerised resin-based material present inside holes 6, 11 and 12 passing through the thickness of the core 2 and of the first and second reinforcement sheet 3 and 4.

The holes 6, 11 and 12 are made by a needling operation with which fibres of the first sheet and second reinforcement sheet 3 and 4 are joined by needling.

Of course, the fibres of the first sheet and second reinforcement sheet 3 and 4 joined by needling are impregnated with the resin-based material present inside the holes 6, 11 and 12.

The first and second reinforcement sheets 3 and 4 are made from identical or even different composite material. According to the type of application the reinforcement sheets 3 and 4 of the panel 1 can give analogous or different mechanical properties.

The resin-based material present in the reinforcement sheets 3 and 4 can be continuous and/or discontinuous, natural and/or synthetic fibre, made from fabric, non-woven fabric, flock, felt, etc.

As an example, each reinforcement sheet 3 and 4 can be made from a fibreglass mattress and a thermosetting epoxy, phenolic or polyurethane resin, etc.

The core 2, instead, as an example can be a PVC or foamed polyurethane slab or a phenolic resin foam, etc., or from another material preferably suitable for being perforated through needling.

The multi-layer panel structure 1 can have an overall parallelepiped configuration with flat faces, but it is also conceivable to have a honeycombed configuration suitable for flexibly adapting to variously shaped surfaces.

Each reinforcement sheet 3 and 4, just like the core 2, can have a single layer structure or in turn a multi-layer structure.

The process for making the multi-layer panel structure 1 consists of applying a first and second fibre-based material 9 and 10 on the opposite faces 7 and 8 of the core 2, joining the first and second fibre-based material 9 and 10 through a needling operation through the thickness of the core 2, carrying out the impregnation of the first and second fibre-based material 9 and 10 with a resin-based material and introducing the resin-based material inside the needling holes 6, 11, 12 for their entire extension, and polymerising the resin-based material so that at least the polymerised resin-based material present in such a plurality of through holes 6, 11 and 12 defines the plurality of structural rigidifying elements 5 that connect the first and second fibre-based material 9 and 10.

The needling can be prior or subsequent to the impregnation, and in the latter case the needling needles themselves advantageously pull the resin-based material inside the needling holes that they create.

More generally, the introduction of the resin-based material into the through holes 6, 11 and 12 is preferably ensured through the exertion of a pressure on the resin-based material.

Such pressure can, as stated, be carried out through the needling needles, but also for example through a vacuum suction system, or a closed-mould injection system.

Advantageously, the needling, the impregnation and the polymerisation are carried out in a continuous process, for example a continuous pultrusion process.

The plant for continuously making a multi-layer laminate 1 has a feed unit 13 of the first and second fibre-based material 9 and 10 on the opposite sides 7 and 8 of the core 2, a needling unit 14 to join fibres of the first and second fibre-based material 9 and 10, an impregnation unit 15 of the fibres with a resin-based material, the impregnation unit 15 having pressing means 16 suitable for applying a pressure on the resin-based material so as to ensure the introduction of the resin-based material also along the entire extension of the needling holes 6 passing through the thickness of the core 2, and a forming unit 17 carrying out, through a suitable forming mould, the forming of the laminate and, through suitable heat treatment, the polymerisation of the resin-based material.

In order to eliminate the possible surface roughness of the laminate that originates due to the friction between the unpolymerised outer reinforcement sheets 3 and 4 and the forming mould of the forming unit 17, it is possible to associate a protective layer (not shown), for example a polyester film, outside one or both of the unpolymerised reinforcement sheets 3 and 4, before entry into the forming unit 17.

The protective layer protects the reinforcement sheet and eliminates the friction between the unpolymerised reinforcement sheet and the forming mould of the forming unit 17, allowing the removal from the reinforcement sheet of resin scraped away at the entry of the forming mould to be limited and allowing a laminate to be obtained with one or both of the surfaces perfectly smooth.

Each protective layer is removable to be detached once the forming operation of the laminate has been completed.

The plant is completed by a pulling unit 18 of the formed laminate, for example with pulling rollers, and by a final cutting unit 19.

The operation of the plant according to the invention is clear from what has been described and illustrated and, in particular, is briefly the following.

The materials 9 and 10, for example formed from “mattresses” of fibre, are unwound from the feed reels of the feeding unit 13, and are associated with the faces 7 and 8 of the core 2.

The assembly consisting of the core 2 and the materials 9 and 10 then enters into the needling unit 14 where the materials 9 and 10 are needled.

The speed at which the needling process is carried out allows high productivity of the plant, especially compared to a conventional pultrusion plant associated with a sewing unit to join fibre materials before impregnation.

At the subsequent stage in the unit 15 the materials 9 and 10 are impregnated with the resin-based material. In this step the pressing means 16 determine the complete impregnation of the materials 9 and 10 and the introduction of the resin-based material also along the entire length of the needling holes made through the materials 9 and 10 during the previous stage.

In the unit 17 the forming and polymerisation of the resin-based material is carried out.

The laminate having the final shape is pulled by the rollers of the unit 18 outside of the unit 17 and is finally subjected to cutting to a predetermined length at the unit 19.

The process for making a multi-layer panel thus conceived can undergo numerous modifications and variations, all of which are covered by the inventive concept; moreover, all of the details can be replaced with technically equivalent elements.

In practice, the materials used, as well as the sizes, can be whatever according to the requirements and the state of the art.

1. Process for making a multi-layer panel, characterised in that a first and second fibre-based material is applied on the opposite faces of a core of said panel, said first and second fibre-based material are joined through a needling operation through the thickness of said core, said first and second fibre-based material are impregnated with a resin-based material and said resin-based material is introduced inside the needling holes for their entire extension, and said resin-based material is polymerised so that at least the polymerised resin-based material present in said needling holes defines a plurality of structural rigidifying elements that connect said first and second fibre-based material.

2. Process according to the previous claim, characterised in that said needling precedes said impregnation.

3. Process according to one or more of the previous claims, characterised in that said needling operation follows said impregnation.

4. Process according to one or more of the previous claims, characterised in that said impregnation is carried out through the application of a pressure on said resin-based material.

5. Process according to one or more of the previous claims, characterised in that said pressure is carried out through a vacuum system.

6. Process according to one or more of the previous claims, characterised in that said pressure is carried out through a closed-mould injection system.

7. Process according to one or more of the previous claims, characterised in that said pressure is carried out by said needling needles.

8. Process according to one or more of the previous claims, characterised in that said needling, said impregnation and said polymerisation are carried out in a continuous process.

9. Process according to one or more of the previous claims, characterised in that said needling, said impregnation and said polymerisation are carried out in a pultrusion process.

10. Process according to one or more of the previous claims, characterised in that after said impregnation and before said polymerisation and the forming of said panel, outside at least one of said first and second fibre-based material a corresponding protective layer is associated that can be removed at the end of said forming so as to obtain a smooth surface of said panel.

11. Multi-layer panel structure, characterised in that it comprises a core arranged between a first reinforcement sheet made from composite material and a second reinforcement sheet made from composite material joined through needling through the thickness of said core, said structure also having a plurality of structural rigidifying elements that connect said first and second reinforcement sheet, said rigidifying elements comprising at least one polymerised resin-based material present inside the needling holes.

12. Multi-layer panel structure according to the previous claim, characterised in that said first and second sheet are made from different composite materials.

13. Multi-layer panel structure according to one or more of the previous claims, characterised in that said resin-based material is thermosetting.

14. Multi-layer panel structure according to one or more of the previous claims, characterised in that said resin-based material is thermoplastic.

15. Multi-layer panel structure according to one or more of the previous claims, characterised in that it has a honeycombed configuration suitable for adapting flexibly to variously shaped surfaces.

16. Plant for continuously making a multi-layer laminate comprising a core arranged between a first reinforcement sheet made from composite material and a second reinforcement sheet made from composite material, characterised in that it has a feed unit of a first and second fibre-based material on the opposite sides of said core, a needling unit to join fibres of said first and second fibre-based material through the thickness of said core, an impregnation unit of said fibres with a resin-based material, said impregnation unit having pressing means suitable for applying a pressure on said resin-based material so as to ensure the introduction of said resin-based material also along the entire extension of the needling holes, and a forming unit carrying out, through suitable heat treatment, the polymerisation of said resin-based material.

17. Structure, process and plant for making a multi-layer panel as described and claimed.
